(19) United States
(12) Patent Application Publication
(10) Pub. No.: US 2016/0196540 A1
(43) Pub. Date: Jul. 7, 2016

(54) SYSTEMS AND METHODS FOR ELECTRONIC MAIL PAYMENTS

(71) Applicant: JPMorgan Chase Bank, N.A., New York, NY (US)

(72) Inventors: Stephen W. Markwell, Chapel Hill, NC (US); Dar F. Isler, Largo, FL (US); Deborah R. Myers, Hilliard, OH (US); Matt VanHouten, Pittsford, NY (US); Andrew R. Stache, Wesley Chapel, FL (US); Maria A. Montealegre, New York, NY (US); Matthew Jordan, Crystal River, FL (US); Tricia Weeks, Dover, FL (US); Raghu Loganathan, Tampa, FL (US); Joe G. Kallarackal, Valrico, FL (US); Marcelo Garcia, Land O Lakes, FL (US); Pankaj Satija, Tampa, FL (US); John Gambale, Lithia, FL (US); Kevin Kidd, Tampa, FL (US)

(21) Appl. No.: 15/054,537

(22) Filed: Feb. 26, 2016

Related U.S. Application Data
(63) Continuation-in-part of application No. 14/106,999, filed on Dec. 16, 2013.
Application No. 14/106,999 is a continuation-in-part of application No. 13/773,855, filed on Feb. 22, 2013.
(60) Provisional application No. 61/762,077, filed on Feb. 7, 2013.

(51) Int. Cl. G06Q 20/10; G06Q 20/32; G06Q 20/38; G06Q 20/36

(52) U.S. Cl. CPC G06Q 20/102; G06Q 20/36; G06Q 20/322; G06Q 20/3821; G06Q 2220/00

(57) ABSTRACT

Systems and methods for payment processing are disclosed. In one embodiment, a method for payment processing may include (1) receiving, at a financial institution, a payment instruction to effectuate a payment to a payee, the payment instruction comprising a payment amount, a payee identifier, and electronic contact information for the payee; (2) at least one financial institution computer processor electronically communicating a payment offer to electronic contact information for the payee, the payment offer comprising a payment amount and an offer to accept electronic payment for the payment amount; (3) receiving, from the payee, acceptance of the payment offer; and (4) the at least one financial institution computer processor causing the payment amount to be electronically transferred to the payee.

### RELATED APPLICATIONS

The present application is a continuation-in-part of U.S. patent application Ser. No. 14/106,999, which is a continuation-in-part application of U.S. patent application Ser. No. 13/773,855, which claims priority to U.S. Provisional Application Ser. No. 61/762,077. This present application is also related to U.S. Pat. No. 7,949,579 and U.S. patent application Ser. Nos. 60/215,003 and 13/735,090. The disclosure of each of these documents is hereby incorporated, by reference, in its entirety.

### BACKGROUND OF THE INVENTION

1. Field of the Invention

The present disclosure generally relates to systems and methods for electronic mail payments.

2. Description of the Related Art

Companies often seek to compensate customers for inconveniences. For example, if an airline passenger's luggage is lost or delayed, the airline will often issue compensation in the form of a paper check by mail to the customer. Issuing a paper check is time consuming and costly, and also results in a compensation delay for the passenger.

### SUMMARY OF THE INVENTION

Systems and methods for payment processing are disclosed. In one embodiment, a method for payment processing may include (1) receiving, at a financial institution, a payment instruction to effectuate a payment to a payee, the payment instruction comprising a payment amount, a payee identifier, and electronic contact information for the payee; (2) at least one financial institution computer processor electronically communicating a payment offer to electronic contact information for the payee, the payment offer comprising a payment amount and an offer to accept electronic payment for the payment amount; (3) receiving, from the payee, acceptance of the payment offer; and (4) the at least one financial institution computer processor causing the payment amount to be electronically transferred to the payee.

In one embodiment, a plurality of payment instructions for a plurality of payments involving a plurality of payees may be received.

In one embodiment, the electronic contact information may include an email address for the payee, a SMS number for the payee, etc.

In one embodiment, the payment offer may further include a link to a website hosted by the at least one financial institution, and the acceptance of the offer is received at the website. It may also include a verification device that may be, for example, an encrypted token, an encrypted cookie, etc. The verification device may be entered at the website.

In one embodiment, the payment offer may also include an expiration date.

In one embodiment, the payment amount may be electronically transferred to an electronic wallet, into a customer account, etc.

In one embodiment, the financial institution may verify that the payment offer is within at least one of a payment amount goal and a payment velocity goal.

According to another embodiment, a method for payment processing may include (1) receiving, at a financial institution, a payment instruction to effectuate a payment to a payee, the payment instruction comprising a payment amount, a payee identifier, and electronic contact information for the payee; (2) at least one financial institution computer processor electronically communicating a payment offer to the electronic contact information for the payee, the payment offer comprising a payment amount and an offer to accept electronic payment for the payment amount; (3) receiving, from the payee, rejection of the payment offer; (4) the at least one financial institution computer processor generating a physical financial instrument for the payment amount; and (5) causing the physical financial instrument to be delivered to the payee.

In one embodiment, a plurality of payment instructions for a plurality of payments involving a plurality of payees may be received.

In one embodiment, the payment instruction may further include a mailing address for the payee.

In one embodiment, the payment offer may further include a link to a website hosted by the at least one financial institution, and the rejection of the offer is received at the website.

It may also include a verification device that may be, for example, an encrypted token, an encrypted cookie, etc. The verification device may be entered at the website.

In another embodiment, a method for payment processing may include (1) receiving, at a financial institution and from a provider of a good or service, an electronic invoice for a customer, the invoice comprising an invoice amount and electronic contact information for the customer; (2) at least one financial institution computer processor electronically communicating the invoice and a link to a website hosted by the financial institution to the electronic contact information for the customer; (3) the at least one financial institution receiving at the website and from the customer, an identification of a payment account to pay the invoice; and (4) the at least one financial institution effectuating payment from the payment account to an account for the provider.

In one embodiment, the invoice may also include a verification device that may be, for example, an encrypted token, an encrypted cookie, etc. The verification device may be entered at the website.

In one embodiment, the payment account may be associated with a mobile wallet.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for electronic mail payments according to one embodiment.

FIG. 2 depicts a method for electronic mail payments according to one embodiment.

FIG. 3 depicts a method for electronic mail bill payment according to one embodiment.

### DETAILED DESCRIPTION OF PREFERRED EMBODIMENTS

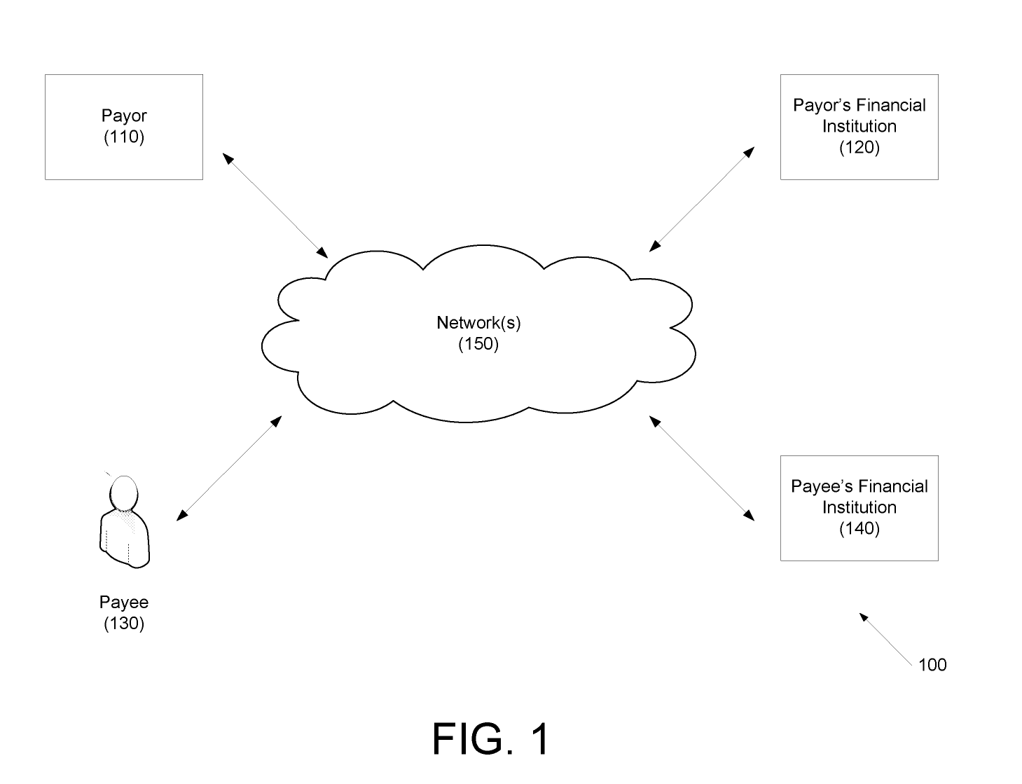

Several embodiments of the present invention and their advantages may be understood by referring to FIGS. 1-3.

Embodiments disclosed herein are generally directed to systems and methods for electronic mail payments.

The following documents are hereby incorporated, by reference, in their entireties: U.S. Pat. No. 8,571,975 and U.S. patent application Ser. No. 13/804,173.

Referring to FIG. 1, a system for electronic mail payment is disclosed according to one embodiment. System 100 may include payor 110, payor's financial institution 120, payee 130, payee's financial institution 140, and network(s) 150.

In one embodiment, payor 110 may be any individual or entity that is making a payment to one or more payee 130.

In one embodiment, payor 110 may have one or more accounts with payor's financial institution 120. Payor's financial institution 120 may be any suitable bank, credit card issuer, credit union, etc. In one embodiment, payor's financial institution may comprise more than one financial institution, such as the clearXchange network of financial institutions.

Payee 130 may be an individual or entity that receives a payment from payor 110. In one embodiment, payee 130 may be a customer of payor 110. For example, payor 110 may be a provider of a good and/or service to payee 130.

In one embodiment, payee 130 may have one or more accounts with payee's financial institution 140. Payee's financial institution 130 may be any suitable bank, credit card issuer, credit union, etc.

In one embodiment, payor's financial institution 120 and payee's financial institution 140 may be the same financial institution.

Network(s) 150 may be any suitable communication network, payment network, or combination thereof.

In one embodiment, a separate entity (not shown) may provide the payment functionality described herein. In one embodiment, the separate entity may be in communication with network(s) 150.

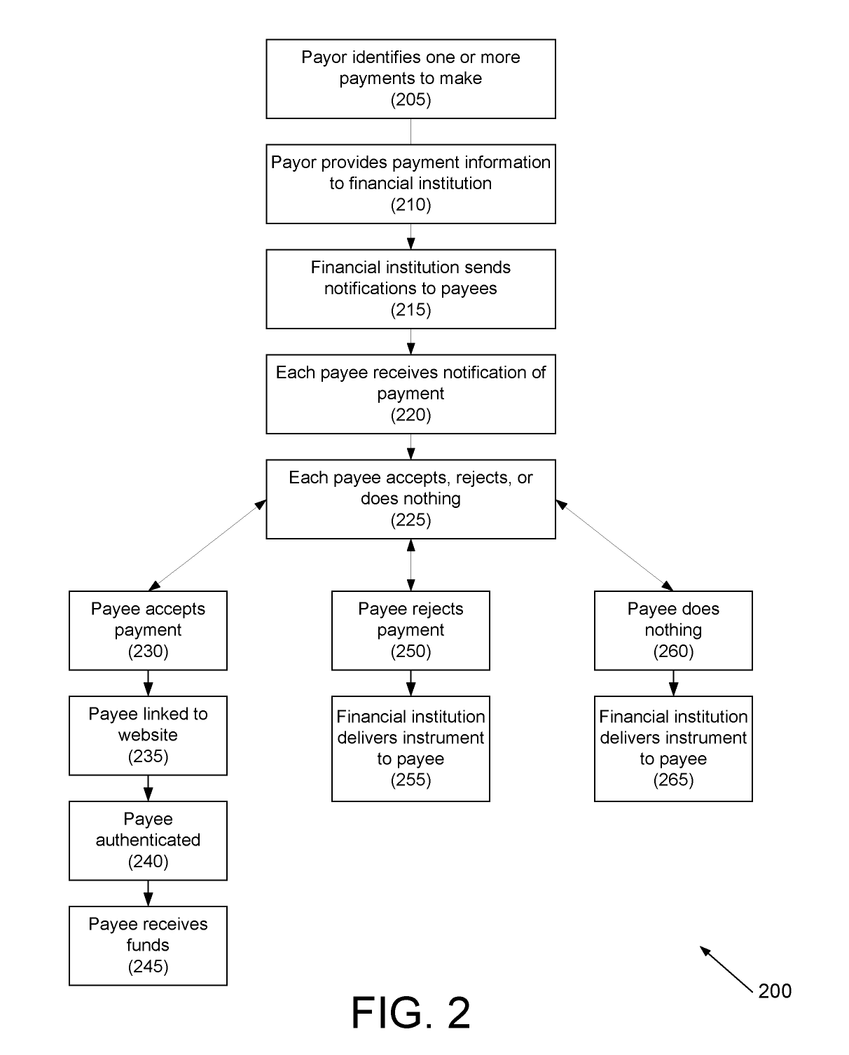

Referring to FIG. 2, a method for electronic mail payment according to one embodiment is disclosed. In step 205, a payor may identify one or more payments to make to one or more payee.

In step 210, the payor may provide payment information to its financial institution. In one embodiment, the payment information may comprise a payee identifier, including one or more of a name, an address, a phone number, an email address, etc. In addition, the payment information may comprise loyalty account information for the payee. In still another embodiment, the payment information may include information that may be used to authenticate the payee (e.g., account number, amount of a recent transaction with the payor, rewards account info, etc.).

In one embodiment, the payment information may further include a reason for the payment, such as “compensation for delayed baggage,” “rebate on your purchase of dog food,” etc.

In one embodiment, the payment information may also include an expiration date for the offer for the electronic funds transfer. Thus, if the payee does not respond before the expiration date, the offer for electronic payment will be deemed rejected.

In one embodiment, the payment may be made in money, reward points (e.g., frequent flyer miles), discounts, merchandise, etc. In one embodiment, the payor may identify multiple payment options (e.g., $50 deposit, 5,000 frequent flyer miles, 20% off next purchase, five magazine subscriptions, etc.) and the payee may decide which option(s) to accept, if any.

In one embodiment, multiple payment formats (e.g., ISO PAIN, X12, custom formats, etc.) may be accepted.

In one embodiment, the payment information for a plurality of payees may be provided to the payor's financial institution in a group. In one embodiment, the group may be uploaded periodically (e.g., nightly), on demand, or as otherwise necessary and/or desired.

In one embodiment, the payment instructions, email, file transmission, and reporting may be processed in batch.

In one embodiment, the payor may verify that the payment meets certain velocity and/or payment amount limits. For example, a payor may limit the number of electronic payments to be within a certain time period (e.g., a day, week, month, etc.). Similarly, a payor may limit the dollar amount of the payments for a certain time period.

In one embodiment, the limits may be on the entire payor entity; in another embodiment, the limits may apply to certain business units, departments, etc. of the payor entity (e.g., sales, marketing, customer service, etc.). The limits may also differ among business units. For example, different business units may have different types of limits and/or limits.

In one embodiment, the payor's financial institution may enforce the payment limits instead of the payor. In another embodiment, a combination of the payor and the payor's financial institution may enforce the payment limits.

In step 215, the financial institution may send an electronic notice to each payee. In one embodiment, the notice may be sent via electronic mail. In another embodiment, the notice may be sent by a messaging service, e.g., SMS, MMS, etc. In another embodiment, the notice may be a push notice on a mobile device through, for example, a mobile wallet, mobile application, etc.

In one embodiment, the financial institution may determine whether the payee has an account with the financial institution, whether the payee has an account with a financial institution within a group or a consortium of financial institutions (e.g., clearXchange, etc.), etc. In one embodiment, the identification of the financial institution in the notice to the payee may differ depending on financial institution with which the payee has an account.

In one embodiment, the notice may provide the payee with information regarding a payment. For example, it may identify the payor, the amount of the payment, and the reason for the payment.

In one embodiment, the notice may also include a link, such as a uniform resource locator (URL), a reply option (e.g., accept or reject), or other instructions to effectuate the payment (e.g., “text ‘YES’ to accept the electronic payment”). In one embodiment, the notice may include an encrypted token, cookie, etc. or other verification means/devices that may be returned to the financial institution for verification purposes.

In one embodiment, if a consortium or other payment network is used, the payee may receive notice from the payee's financial institution regarding the payment offer.

In step 220, each payee may receive a notice of payment, and in step 225, each payee may either accept the payment, reject the payment, or may take no action.

In one embodiment, if the payee does not take an action, the offer may expire.

In one embodiment, the payee may reply to the notice with either “accept” or “reject,” may select a “button,” a link, etc. in the notice to indicate his or her intention, or may otherwise indicate his or her intention in any suitable manner.

If, in step 230, the payee accepts payment, in step 235, the payee may be directed to a website to complete the payment process. For example, in one embodiment, the payee may click on a link. In another embodiment, the payee may reply to accept the electronic payment, and may then be sent a link.

In one embodiment, the encrypted token, cookie, or other verification means/device(s) may be passed back to the link to authenticate the message that was sent to the payee.

In step 240, the payee may be authenticated. In one embodiment, the financial institution may use out-of-band authentication (e.g., SMS if notice was by email, and vice-versa) to authenticate the payee. In another embodiment, the payee may be authenticated using biometric authentication on the payee's mobile device. In another embodiment, the payee may be asked to enter information provided by the payor (e.g., account number, recent transaction information, rewards account number, etc.). In still another embodiment, the user may be asked out of wallet questions.

In one embodiment, if the payee has not used the service before, the payee may need to register an account that will receive the payment. In one embodiment, the payee may identify an account by providing a routing number and an account number. In another embodiment, the payee may provide an online banking identifier. In still another embodiment, the payee may identify an account within an electronic wallet. In another embodiment, the payee may identify an account using biometrics.

An example of the use of biometrics is disclosed in U.S. patent application Ser. No. 14/980,513 and U.S. patent application Ser. No. 15/012,081, the disclosures of which are incorporated, by reference, in their entireties.

In step 245, the payee may receive funds from the payor. In one embodiment, the payment may be made by ACH, Faster Payments, wire, virtual stored value cards, rewards, etc. In one embodiment, the payments to multiple payees may be made in batch.

In one embodiment, machine learning may be used to refine the payment process. For example, if a payee has been offered an electronic payment before, and has rejected electronic payments a certain number of times, the payee may not be offered electronic payment again and will be sent a check or other compensation. Similarly, if the payee has accepted electronic payments before, and has identified an account to receive payments, the notification may inform the payee of the impending transfer. In one embodiment, the payee may still receive a notice, and may still be given an opportunity to opt out of the electronic payment.

In addition, machine learning may be used to identify recurring payments. For example, if the payor sends a payee $50 every month for a certain number of months, the system may proactively identify this as a recurring payment and establish a recurring payment.

In one embodiment, the payments may be used to provide reporting to the payor. The system may recommend an industry-standard format for the reporting; in another embodiment, the payor may customize reporting format. For example, the payor may identify specific fields that may be relevant (e.g., number of declines, ACH vs. check, dollar amount, etc.).

In one embodiment, the report may be transmitted to the payor as is necessary and/or desired.

If the payee rejects the payment in step 250, or does nothing in step 260, then in steps 255 and 260, respectively, the financial institution may generate and deliver, by mail, a paper check or stored value card for the amount of payment to the payor. If alternate compensation (e.g., rewards points) are used, the points may be deposited into the payee's loyalty account.

In one embodiment, the notice that is sent may “bounce back” to the sender. This may indicate, for example, that the email address or SMS address is invalid, the payee's mailbox is full, there is network congestion/issues, etc. In one embodiment, if the notice is returned, one or more additional attempt may be made to deliver the notice. In another embodiment, the returned notice may act as a rejection of the offer, or it may expire the offer.

In one embodiment, the returned notice may be included in machine learning so that if a notice is returned, future payments may automatically be sent by mail.

In one embodiment, payments may be made by outsourcing the printing of checks. In one embodiment, if the value is above a certain amount (e.g., $3,000), the check may be “sanction scanned” to comply with anti-money laundering regulations. In another embodiment, payroll checks of any amount may not be sanction scanned.

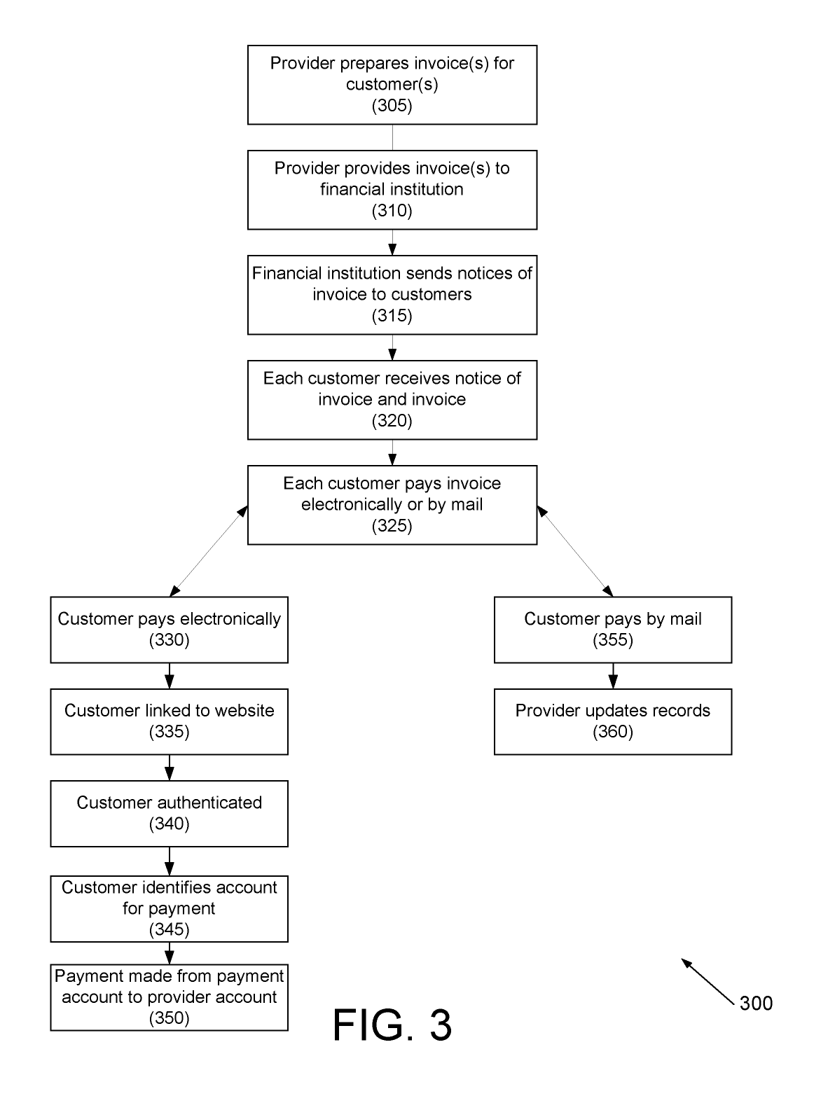

Referring to FIG. 3, a method for electronic mail bill payment is provided according to one embodiment.

In step 305, a provider of goods/services may prepare an invoice for one or more customers. The customers may be individuals, businesses, etc. The invoices may include a customer identifier (e.g., an account number), customer contact information (e.g., name, address, phone number, email address, etc.).

In step 310, the provider may provide the invoice to its financial institution. In one embodiment, the invoices may be provided in batch.

In step 315, the financial institution may send a notice of the invoice to the customer. In one embodiment, the notice may be sent by email, SMS, etc. In one embodiment, the invoice may include options to pay the invoice electronically, or to pay the invoice by mail.

In one embodiment, the notice may include a link to a website, a reply option (e.g., pay electronically or pay by mail), or other instructions to effectuate the payment. In one embodiment, the notice may include an encrypted token, cookie, etc. that may be returned to the financial institution for verification purposes.

In step 320, the customer may receive the notice of invoice and the invoice.

In step 325, the customer may decide to pay the invoice electronically or pay the invoice by mail.

If, in step 330, the customer decides to pay the invoice electronically, in step 335, the customer may be linked to a website. In one embodiment, this website may be hosted by the provider's financial institution.

In step 340, the customer may be authenticated.

In step 345, the customer may enter account information for the financial account that will be used to pay the invoice. In one embodiment, the account may be with a financial institution that is different from the provider's financial institution.

In one embodiment, the customer may set up parameters for recurring payments, request e-billing, etc.

In step 350, the payment may be provided to the provider. Any suitable payment challenge, such as ACH, Faster Payments, clearXchange, etc. may be used as is necessary and/or desired.

In step 355, if the customer decides to pay the invoice by mail, in step 360, the provider may update its records to this preference.

It should be recognized that although several embodiments have been disclosed, these embodiments are not exclusive and aspects of one embodiment may be applicable to other embodiments.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for payment processing, comprising:
receiving, at a financial institution, a payment instruction to effectuate a payment to a payee, the payment instruction comprising a payment amount, a payee identifier, and electronic contact information for the payee;
at least one financial institution computer processor electronically communicating a payment offer to electronic contact information for the payee, the payment offer comprising a payment amount and an offer to accept electronic payment for the payment amount;
receiving, from the payee, acceptance of the payment offer; and
the at least one financial institution computer processor causing the payment amount to be electronically transferred to the payee.

2. The method of claim 1, wherein a plurality of payment instructions for a plurality of payments involving a plurality of payees are received.

3. The method of claim 1, wherein the electronic contact information comprises an email address for the payee.

4. The method of claim 1, wherein the payment offer further comprises a link to a website hosted by the at least one financial institution, and the acceptance of the offer is received at the website.

5. The method of claim 4, wherein the payment offer further comprises a verification device, and the verification device is provided to the website.

6. The method of claim 5, wherein the verification device comprises one of an encrypted token and an encrypted cookie.

7. The method of claim 1, wherein the payment offer further comprises an expiration date.

8. The method of claim 1, wherein the payment amount is electronically transferred to an electronic wallet.

9. The method of claim 1, wherein the payment amount is electronically deposited to a customer account.

10. The method of claim 1, wherein the financial institution verifies that the payment offer is within at least one of a payment amount goal and a payment velocity goal.

11. A method for payment processing, comprising:
receiving, at a financial institution, a payment instruction to effectuate a payment to a payee, the payment instruction comprising a payment amount, a payee identifier, and electronic contact information for the payee;
at least one financial institution computer processor electronically communicating a payment offer to the electronic contact information for the payee, the payment offer comprising a payment amount and an offer to accept electronic payment for the payment amount;
receiving, from the payee, rejection of the payment offer;
the at least one financial institution computer processor generating a physical financial instrument for the payment amount; and
causing the physical financial instrument to be delivered to the payee.

12. The method of claim 11, wherein a plurality of payment instructions for a plurality of payments involving a plurality of payees are received.

13. The method of claim 11, wherein the payment instruction further comprises a mailing address for the payee.

14. The method of claim 11, wherein the payment offer further comprises a link to a website hosted by the at least one financial institution, and the rejection of the offer is received at the website.

15. The method of claim 14, wherein the payment offer further comprises a verification device, and the verification device is received at the website.

16. The method of claim 15, wherein the verification device comprises one of an encrypted token and an encrypted cookie.

17. A method for payment processing, comprising:
receiving, at a financial institution and from a provider of a good or service, an electronic invoice for a customer, the invoice comprising an invoice amount and electronic contact information for the customer;
at least one financial institution computer processor electronically communicating the invoice and a link to a website hosted by the financial institution to the electronic contact information for the customer;
the at least one financial institution receiving at the website and from the customer, an identification of a payment account to pay the invoice; and
the at least one financial institution effectuating payment from the payment account to an account for the provider.

18. The method of claim 17, wherein the invoice further comprises a verification device, and the verification device is received at the website.

19. The method of claim 18, wherein the verification device comprises one of an encrypted token and an encrypted cookie.

20. The method of claim 17, wherein the payment account is associated with a mobile wallet.
